(19) United States
(12) Patent Application Publication
(10) Pub. No.: US 2013/0271771 A1
(43) Pub. Date: Oct. 17, 2013

(54) INTERFERENCE MEASUREMENT DEVICE

(71) Applicant: Sumitomo Electric Industries, Ltd., Osaka (JP)

(72) Inventor: Eisuke SASAOKA, Yokohama-shi (JP)

(21) Appl. No.: 13/836,161

(22) Filed: Mar. 15, 2013

Related U.S. Application Data
(60) Provisional application No. 61/700,551, filed on Sep. 13, 2012.

(30) Foreign Application Priority Data
Mar. 23, 2012 (JP) 2012-067780
Jul. 3, 2012 (JP) 2012-149530

(51) Int. Cl. G01B 9/02; G02B 6/26

(52) U.S. Cl. CPC G01B 9/02049; G02B 6/26
USPC 356/477; 385/31

(57) ABSTRACT

The present invention relates to an interference measurement device comprising a multi-core optical fiber having first and second ends, a light source, an optical receiver, a branching unit, a coupling unit, a measurement optical path, and a reference optical path and measures a physical quantity of an object to be measured on the measurement optical path. The light source and optical receiver are arranged on the first end side, while the measurement optical path and reference optical path are arranged on the second end side. The branching unit splits light from the light source into measurement light and reference light, while the coupling unit generates interference light between the measurement light having propagated through the measurement optical path and the reference light having propagated through the reference optical path. The optical receiver detects the intensity of the interference light.

### BACKGROUND OF THE INVENTION

1. Field of the Invention

The present invention relates to an interference measurement device.

2. Related Background of the Invention

Measurement devices using optical fibers have been known. The measurement devices disclosed in Japanese Patent No. 2706281 (Patent Document 1) and Japanese Patent Application Laid-Open No. 4-307328 (Patent Document 2) use a multi-core optical fiber having plural cores as a sensor unit and detect changes in temperature, pressure, tension, and the like according to changes in optical coupling between the cores. The measurement device disclosed in Japanese Patent Application Laid-Open No. 2003-229598 (Patent Document 3) causes measurement light outputted from a light source to propagate through a core in the multi-core optical fiber to an object to be measured, allows reflected light from the object to propagate through the other core to an optical receiver, and measures a physical quantity of the object according to the quantity of reflected light detected by the optical receiver. Interference measurement devices using optical fibers as sensor units have also been known.

### SUMMARY OF THE INVENTION

The inventors studied conventional devices such as those mentioned above and, as a result, have found the following problems. Types of physical quantities measurable in the measurement devices disclosed in the above-mentioned Patent Documents 1, 2 are limited to those influencing the optical coupling between the cores of the multi-core optical fiber. In the measurement devices disclosed in the above-mentioned Patent Documents 1, 2, the changes in optical coupling between cores of the multi-core optical fiber are required to have such a magnitude as to be detectable by measurement of the output optical power from each core. Types of physical quantities measurable in the measurement device disclosed in Patent Document 3 are limited to those influencing the quantity of reflected light from the object. The physical quantities measurable in the measurement device disclosed in Patent Document 3 are also required to have such a magnitude as to be detectable as a change in the quantity of reflected light. The types and magnitude of measurable physical quantities are limited in the measurement devices disclosed in Patent Documents 1 to 3.

In an interference measurement device using an optical fiber as a sensor unit, a change in the phase difference between measurement light and reference light caused by a change in a physical quantity other than the one to be measured, if any, generates measurement noise. When measuring temperature, for example, the phase difference between the measurement light and reference light is easily changed by disturbances other than temperature, such as pressure and tension, in a conventional structure using optical fibers as a sensor unit in which optical fibers for propagating the measurement light and reference light are different from each other. This makes it necessary to take measures to eliminate the noise caused by disturbances of physical quantities other than the physical quantity to be measured, which complicates the structure of the measurement device.

For solving the problems mentioned above, it is an object of the present invention to provide an interference measurement device which can measure various types of physical quantities in a simple structure.

As a first aspect, the interference measurement device according to the present invention comprises, at least, a multi-core optical fiber, a light source, an optical receiver, a measurement optical path, a reference optical path, a branching unit, and a coupling unit. The multi-core optical fiber has a first end and a second end opposing the first end, and further has plural cores extending between the first and second ends, and a common cladding covering the plural cores. The light source is arranged on the first end side of the multi-core optical fiber. The optical receiver is also arranged on the first end side of the multi-core optical fiber. The measurement optical path is arranged on the second end side of the multi-core optical fiber. The reference optical path is also arranged on the second end side of the multi-core optical fiber. The branching unit splits light outputted from the light source into measurement light for propagating through the measurement optical path and reference light for propagating through the reference optical path. The coupling unit generates interference light between the measurement light and reference light by coupling the measurement light having propagated through the measurement optical path and the reference light having propagated through the reference optical path, and feeds thus generated interference light to the optical receiver. This allows the optical receiver to detect the intensity of the interference light. The plural cores of the multi-core optical fiber include at least one core (one or more cores) belonging to a first transmission path for propagating light from the first end to the second end and at least one core (one or more cores) belonging not to the first transmission path but to a second transmission path for propagating light from the second end to the first end.

As a second aspect applicable to the first aspect, it is preferable that the multi-core optical fiber is substantially free of a sensing function. Also, the measurement optical path and the reference optical path may be substantially free of a sensing function. As a third aspect applicable to at least one of the first and second aspects, the branching unit may be arranged on the second end side of the multi-core optical fiber. In this case, the branching unit in the third aspect splits the light from the light source outputted from the core belonging to the first transmission path at the second end of the multi-core optical fiber into the measurement light and reference light. As a fourth aspect applicable to at least one of the first to third aspects, the coupling unit may be arranged on the second end side of the multi-core optical fiber. In this case, the coupling unit in the fourth aspect feeds the interference light between the measurement light having propagated through the measurement optical path and the reference light having propagated through the reference optical path into the core belonging to the second transmission path from the second end side of the multi-core optical fiber.

As a fifth aspect applicable to at least one of the first to fourth aspects, the branching unit may be arranged on the first end side of the multi-core optical fiber. In this case, the branching unit in the fifth aspect feeds the measurement light split from the light outputted from the light source into a core belonging to the first transmission path from the first end side of the multi-core optical fiber and the reference light split from the light outputted from the light source into another core belonging to the first transmission path from the first end side of the multi-core optical fiber. Hence, at least two cores belong to the first transmission path in the fifth aspect. As a sixth aspect applicable to at least one of the first to fifth aspects, the coupling unit may be arranged on the first end side of the multi-core optical fiber. In this case, the coupling unit in the sixth aspect couples the measurement light and reference light outputted from the first end of the multi-core optical fiber after having propagated through respective two cores different from each other belonging to the second transmission path, so as to generate the interference light, and feeds thus generated interference light into the optical receiver. Hence, at least two cores belong to the second transmission path in the sixth aspect.

As described above, with respect to the multi-core optical fiber, the third to sixth aspects can actualize, at least, a first structure in which both of the branching and coupling units are arranged on the first end side, a second structure in which both of the branching and coupling units are arranged on the second end side, a third structure in which the branching and coupling units are arranged on the first and second end sides, respectively, and a fourth structure in which the branching and coupling units are arranged on the second and first end sides, respectively. In the third and fourth structures in which the branching and coupling units are arranged so as to hold the multi-core optical fiber therebetween in particular, the number of cores belonging to the first transmission path differs from that of cores belonging to the second transmission path. Two branching units may be arranged on both of the first and second end sides in the multi-core optical fiber. Two coupling units may be arranged on both of the first and second end sides in the multi-core optical fiber.

As a seventh aspect applicable to at least one of the first to sixth aspects, the multi-core optical fiber may have first, second, third, and fourth cores as the plural cores, for example. Preferably, in particular in a cross section perpendicular to a center axis (fiber axis) of the multi-core optical fiber, the first and second cores are arranged at positions symmetrical to each other about the center axis, and the third and fourth cores are arranged at positions symmetrical to each other about the center axis. In this case, the first and third cores belong to the first transmission path, while the second and fourth cores belong to the second transmission path.

As an eighth aspect applicable to at least one of the first to seventh aspects, each of the plural cores of the multi-core optical fiber is a polarization-maintaining core. In a ninth aspect applicable to at least one of the first to eighth aspects, at least one of the measurement light and reference light is depolarized or polarization-scrambled.

As a tenth aspect applicable to at least one of the first to ninth aspects, the interference measurement device may comprise a multi-core optical fiber coupler adapted to function as the branching and coupling units. The multi-core optical fiber coupler has a cladding incorporating plural core-groups therein and a leakage reduction unit incorporated in the cladding. In particular, each of the plural core-groups is configured to branch off a part of light propagating through one core to the other core or couple light propagating through one core and light propagating through the other core. The leakage reduction unit is disposed between different core-groups of the plural core-groups and suppresses crosstalk between the different core-groups. Each of the plural core-groups includes plural cores configured to branch or couple light due to crosstalk between cores within the same core-group.

As an eleventh aspect, the multi-core optical fiber coupler according to the present invention has a cladding incorporating plural core-groups therein and a leakage reduction unit incorporated in the cladding. In particular, each of the plural core-groups is configured to branch off part of light propagating through one core to the other core or couple light propagating through one core and light propagating through the other core. The leakage reduction unit is disposed between different core-groups of the plural core-groups and suppresses crosstalk between the different core-groups. Each of the plural core-groups includes plural cores configured to branch or couple light due to crosstalk between cores within the same core-group.

### BRIEF DESCRIPTION OF THE DRAWINGS

FIG. 1 is a diagram illustrating the structure of the interference measurement device according to the first embodiment;

FIGS. 2A and 2B are diagrams for explaining an example of application of each of the first and sixth embodiments;

FIG. 3 is a diagram illustrating the structure of the interference measurement device according to the second embodiment;

FIG. 4 is a sectional view of a multi-core optical fiber 10;

FIGS. 5A and 5B are diagrams for explaining an example of application of each of the second to sixth, seventh, and eighth embodiments;

FIG. 6 is a diagram illustrating the structure of the interference measurement device according to the third embodiment;

FIG. 7 is a diagram illustrating the structure of the interference measurement device according to the fourth embodiment;

FIG. 8 is a diagram illustrating the structure of the interference measurement device according to the fifth embodiment;

FIGS. 9A and 9B are diagrams illustrating the structure of the interference measurement device according to the sixth embodiment;

FIGS. 10A to 10C are sectional views of components of the interference measurement device according to the sixth embodiment;

FIG. 11 is a diagram illustrating the structure of the interference measurement device according to the seventh embodiment;

FIGS. 12A and 12B are sectional views of components of the interference measurement device according to the seventh embodiment; and

FIG. 13 is a diagram illustrating the structure of the interference measurement device according to the eighth embodiment.

### DESCRIPTION OF THE PREFERRED EMBODIMENTS

In the following, embodiments of the present invention will be explained in detail with reference to the accompanying drawings. In the drawings, the same or equivalent parts will be referred to with the same signs while omitting their overlapping descriptions.

### First Embodiment

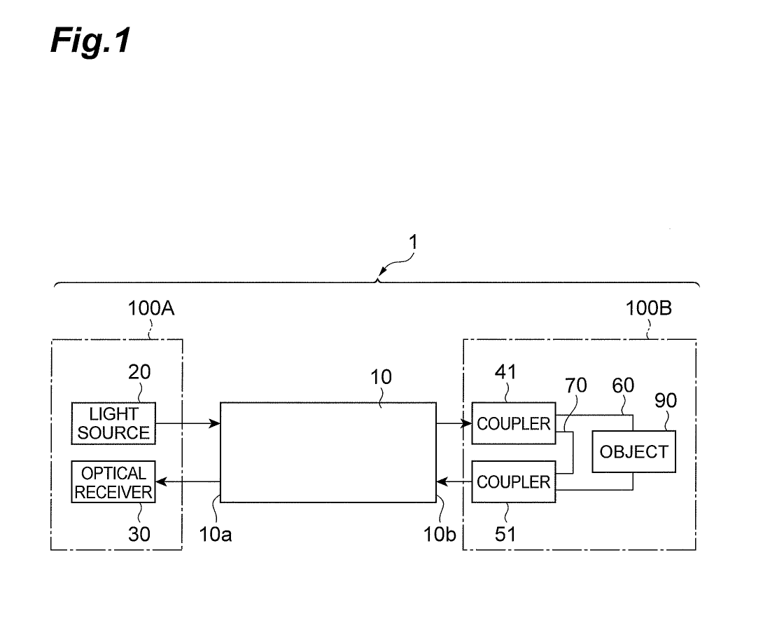

FIG. 1 is a diagram illustrating the structure of the interference measurement device according to the first embodiment. The interference measurement device 1 according to the first embodiment comprises a multi-core optical fiber 10, a light source 20, an optical receiver 30, a branching unit 41, a coupling unit 51, a measurement optical path 60, and a reference optical path 70. The interference measurement device 1 can measure a physical quantity of an object to be measured 90 on the measurement optical path 60. The multi-core optical fiber 10, the measurement optical path 60, and the reference optical path 70 are substantially free of a sensing function.

The multi-core optical fiber 10 has plural cores extending between a first end 10a and a second end 10b within a common cladding. The light source 20 and optical receiver 30 are arranged on the first end 10a side of the multi-core optical fiber 10, so as to constitute a first-end-side element 100A. The branching unit 41, coupling unit 51, measurement optical path 60, and reference optical path 70 are arranged on the second end 10b side of the multi-core optical fiber 10, so as to constitute a second-end-side element 100B. The branching unit 41, coupling unit 51, measurement optical path 60, and reference optical path 70 also constitute a Mach-Zehnder interferometer.

Light outputted from the light source 20 enters a core (a core belonging to a first transmission path adapted to propagate light from the first end 10a to the second end 10b) at the first end 10a of the multi-core optical fiber 10 and exits from the core at the second end 10b to the branching unit 41. The light having entered the branching unit 41 is split into measurement light and reference light. The measurement light outputted from the branching unit 41 enters the coupling unit 51 through the measurement optical path 60 where the object 90 exists. The reference light outputted from the branching unit 41 enters the coupling unit 51 through the reference optical path 70.

The measurement light and reference light having entered the coupling unit 51 interfere with each other as being coupled, and the resulting interference light exits from the coupling unit 51. The interference light enters another core (a core belonging to a second transmission path adapted to propagate light from the second end 10b to the first end 10a) at the second end 10b of the multi-core optical fiber 10 and exits from the core at the first end 10a, so as to be received by the optical receiver 30. At this time, the intensity of the interference light is detected by the optical receiver 30. In the plural cores of the multi-core optical fiber 10, the core propagating light from the first end 10a to the second end 10b and the core propagating light from the second end 10b to the first end 10a differ from each other.

When the phase of the measurement light having passed through the object 90 changes, the phase difference between the measurement light and reference light fed to the coupling unit 51 varies, whereby the interference light alters its intensity. As a result, a change in the object 90 which shifts the phase of light, if any, can be detected by the optical receiver 30 as a change in intensity of interference light. The interference measurement device 1 can measure various types of physical quantities in a simple structure.

As the object 90, an optical fiber can be used. Utilizing the fact that the refractive index and length of the optical fiber vary depending on temperature, pressure, tension, and the like, the interference measurement device 1 can be used as a temperature sensor, a pressure sensor, or a tension sensor. The object 90 is not limited to the optical fiber in this embodiment. When a material whose refractive index varies depending on kinds and concentrations of chemical substances thereabout is used as the object 90, for example, the interference measurement device 1 can be utilized as a chemical sensor. When a material whose refractive index varies depending on the electromagnetism thereabout is used as the object 90, for example, the interference measurement device 1 can be utilized as an electromagnetic sensor (antenna).

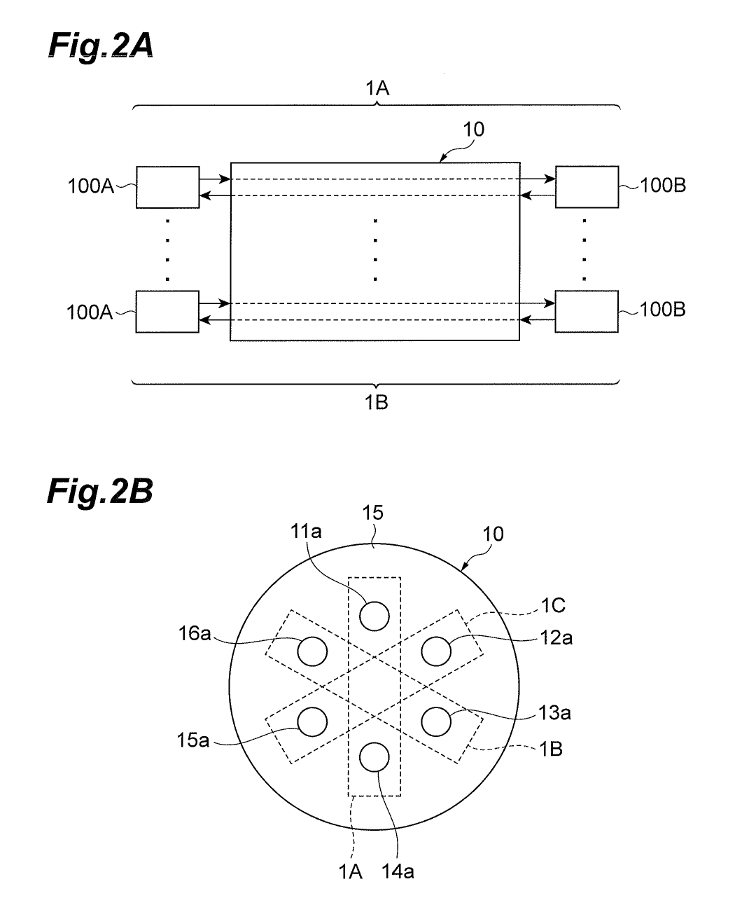

FIGS. 2A and 2B are diagrams for explaining an example of application of the first embodiment. The structure illustrated in FIGS. 2A and 2B is also applicable to the sixth embodiment, which will be explained later. That is, the interference measurement device 1 according to the first embodiment illustrated in FIG. 1 can be actualized when the multi-core optical fiber 10 has at least one core belonging to the first transmission path and at least one core belonging to the second transmission path.

Therefore, when the number of cores in the multi-core optical fiber 10 is a multiple of 2 (specifically when the number of cores is 2, 4, 6, 8, . . . ), arranging first-end-side elements 100A and second-end-side elements 100B at both ends of the multi-core optical fiber 10 as illustrated in FIG. 2A can actualize plural measurement systems 1A, 1B, . . . , each having the same structure as that in FIG. 1. When the multi-core optical fiber 10 has six cores 11a to 16a within a common cladding 15 as illustrated in FIG. 2B, for example, a set of cores opposing each other across the center axis of the multi-core optical fiber 10 (one core belonging to the first transmission path while the other core belonging to the second transmission path) can actualize plural measurement systems optically independent from each other. Specifically, the example of FIG. 2B constructs a measurement system 1A having a set of cores 11a, 14a as a set of the first and second transmission paths, a measurement system 1B having a set of cores 13a, 16a as a set of the first and second transmission paths, and a measurement system 1C having a set of cores 12a, 15a as a set of the first and second transmission paths.

### Second Embodiment

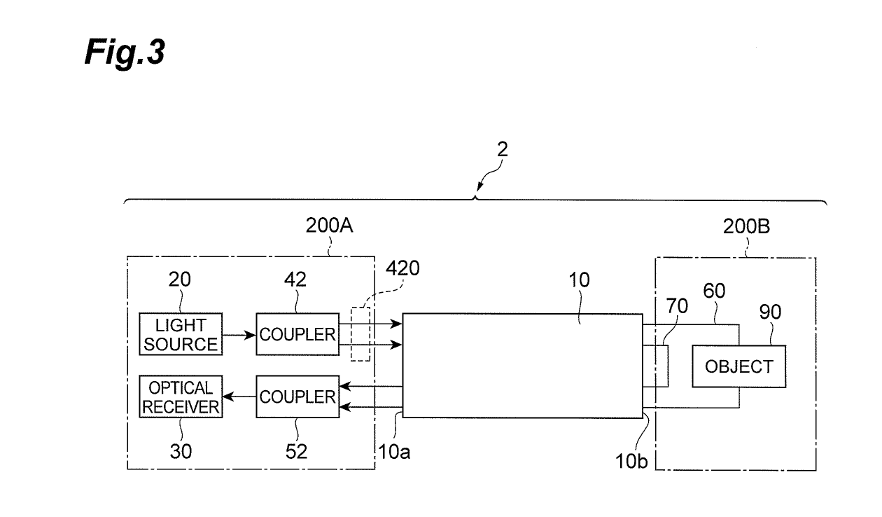

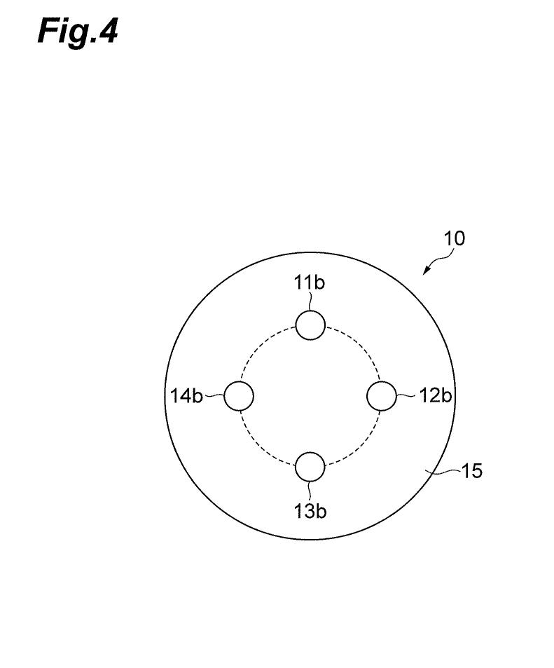

FIG. 3 is a diagram illustrating the structure of the interference measurement device according to the second embodiment. FIG. 4 is a sectional view of a multi-core optical fiber 10 employable in this embodiment. The interference measurement device 2 according to the second embodiment comprises the multi-core optical fiber 10, a light source 20, an optical receiver 30, a branching unit 42, a coupling unit 52, a measurement optical path 60, and a reference optical path 70. The interference measurement device 2 can measure a physical quantity of an object to be measured 90 on the measurement optical path 60. The multi-core optical fiber 10, the measurement optical path 60, and the reference optical path 70 are substantially free of a sensing function.

The multi-core optical fiber 10 has at least four cores 11b to 14b (see FIG. 4) extending between a first end 10a and a second end 10b within a common cladding 15. The light source 20, optical receiver 30, branching unit 42, and coupling unit 52 are arranged on the first end 10a side of the multi-core optical fiber 10, so as to constitute a first-end-side element 200A. The measurement optical path 60 and reference optical path 70 are arranged on the second end 10b side of the multi-core optical fiber 10, so as to constitute a second-end-side element 200B. The branching unit 42, coupling unit 52, multi-core optical fiber 10, measurement optical path 60, and reference optical path 70 also constitute a Mach-Zehnder interferometer.

Light outputted from the light source 20 is split by the branching unit 42 into two, so as to become measurement light and reference light. The measurement light outputted from the branching unit 42 enters the first core 11b (a core belonging to the first transmission path) at the first end 10a of the multi-core optical fiber 10 and exits from the first core 11b at the second end 10b to the measurement optical path 60 where the object 90 exists. The light having traveled the measurement optical path 60 enters the second core 13b (a core belonging to the second transmission path) at the second end 10b of the multi-core optical fiber 10 and exits from the second core 13b at the first end 10a to the coupling unit 52.

The reference light outputted from the branching unit 42 enters the third core 14b (a core belonging to the first transmission path) at the first end 10a of the multi-core optical fiber 10 and exits from the third core 14b at the second end 10b to the reference optical path 70. The light having traveled the reference optical path 70 enters the fourth core 12b (a core belonging to the second transmission path) at the second end 10b of the multi-core optical fiber 10 and exits from the fourth core 12b at the first end 10a to the coupling unit 52. The measurement light and reference light having entered the coupling unit 52 are coupled, and the resulting interference light is received by the optical receiver 30. As a result, the optical receiver 30 detects the intensity of the interference light.

In this embodiment, not only the light source 20 and optical receiver 30 but the branching unit 42 and coupling unit 52 are also arranged on the first end 10a side of the multi-core optical fiber 10. This simplifies the structure on the second end 10b side of the multi-core optical fiber 10, thereby making it easier to reduce the size on the second end 10b side, which is effective in particular when the space for the object 90 is limited.

In this embodiment, the cores 11b to 14b also constitute a part of arms of the Mach-Zehnder interferometer. The cores 11b to 14b are arranged within the same cladding 15 and thus are less susceptible to disturbances such as changes in temperature of the multi-core optical fiber 10 and changes in tensions applied to the multi-core optical fiber 10. That is, the phase difference between the measurement light and reference light is hard to change under the influence of the disturbances.

As illustrated in FIG. 4, in a cross section perpendicular to a center axis (fiber axis) of the multi-core optical fiber 10 in this embodiment, the first core 11b and second core 13b are located at positions symmetrical to each other about the center axis, while the third core 14b and fourth core 12b are located at positions symmetrical to each other about the center axis. The first core 11b, as a core belonging to the first transmission path, propagates the measurement light from the first core 10a to the second core 10b, while the second core 13b, as a core belonging to the second transmission path, propagates the measurement light from the second end 10b to the first end 10a. On the other hand, the third core 14b, as a core belonging to the first transmission path, propagates the reference light from the first end 10a to the second end 10b, while the fourth core 12b, as a core belonging to the second transmission path, propagates the reference light from the second end 10b to the first end 10a. Such a structure can be less susceptible to bends imparted to the multi-core optical fiber 10, since the measurement light and reference light traveling back and forth cancel out the optical path difference occurring when bending the multi-core optical fiber 10.

When each of the cores 11b to 14b in the multi-core optical fiber 10 is a polarization-maintaining core or when at least one of the measurement light and reference light is depolarized or polarization-scrambled by a polarizer (or depolarizer) which can be arranged between the coupler 42 and the multi-core optical fiber 10, the interference light can be restrained from changing its intensity because of fluctuations in polarization in the multi-core optical fiber 10 in this embodiment.

In the cross section illustrated in FIG. 4, the cores 11b to 14b for propagating the measurement light and reference light are arranged on the circumference of a circle whose center is at the center axis of the cladding 15, the cores 11b and 13b respectively used as forward and backward paths for the measurement light are arranged at positions opposing each other across the cladding center axis, while the cores 14b and 12b respectively used as forward and backward paths for the reference light are arranged at positions opposing each other across the center axis of the cladding 15. Therefore, when the multi-core optical fiber 10 is bent such that the first core 11b for the forward path of the measurement light is on the outer side, the second core 13b for the backward path of the measurement light is located on the inner side, so that they cancel each other out, whereby the measurement light attains a constant optical path length. The same holds for the reference light.

While the number of cores in the multi-core optical fiber 10 is 4 (for one object to be measured) in an example of the cross section of the multi-core optical fiber 10 illustrated in FIG. 4, it is not restrictive; the number of cores may be 8, 12, 16, . . . (multiples of 4), for example. Without being limited to the case where all the cores are arranged on the same circumference of a circle as illustrated in FIG. 4, cores may be arranged on circumferences of plural circles whose center is at the center axis of the cladding 15. However, the cores canceling out the optical path difference caused by bending the multi-core optical fiber are arranged on the circumference of the same circle at positions opposing each other across the cladding center also in this case.

When the phase of the measurement light having passed through the object 90 changes, the phase difference between the measurement light and reference light entering the coupling unit 52 varies, whereby the interference light shifts its intensity. As a result, a change in the object 90 which shifts the phase of light, if any, can be detected by the optical receiver 30 as a change in intensity of interference light. The interference measurement device 2 can measure various types of physical quantities in a simple structure.

As the object 90, an optical fiber can be used. Utilizing the fact that the refractive index and length of the optical fiber vary depending on temperature, pressure, tension, and the like, the interference measurement device 2 can be used as a temperature sensor, a pressure sensor, or a tension sensor. The object 90 is not limited to the optical fiber in this embodiment. When a material whose refractive index varies depending on kinds and concentrations of chemical substances thereabout is used as the object 90, for example, the interference measurement device 2 can be utilized as a chemical sensor. When a material whose refractive index varies depending on the electromagnetism thereabout is used as the object 90, for example, the interference measurement device 2 can be utilized as an electromagnetic sensor (antenna).

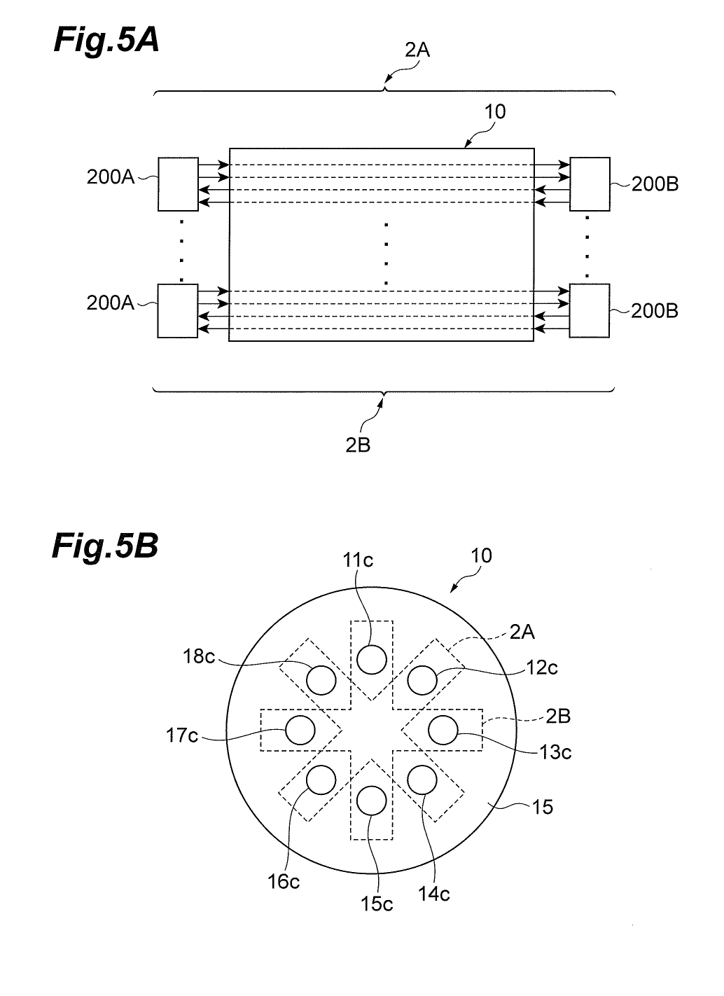

FIGS. 5A and 5B are diagrams for explaining an example of application of the second embodiment. The structure illustrated in FIGS. 5A and 5B is also applicable to the third to fifth, seventh, and eighth embodiments, which will be explained later. That is, the interference measurement device 2 according to the second embodiment illustrated in FIG. 3 can be actualized when the multi-core optical fiber 10 has at least two cores belonging to the first transmission path and at least two cores belonging to the second transmission path.

Hence, when the number of cores in the multi-core optical fiber 10 is a multiple of 4, arranging the first-end-side elements 200A and second-end-side elements 200B at both ends of the multi-core optical fiber 10 as illustrated in FIG. 5A can actualize plural measurement systems 3A, 3B, . . . (or three or more systems) each having the same structure as that in FIG. 3. When the multi-core optical fiber 10 has eight cores 11c to 18c within the common cladding 15 as illustrated in FIG. 5B, for example, two set of cores opposing each other across the center axis of the multi-core optical fiber 10 (each set including one core belonging to the first transmission path and the other core belonging to the second transmission path) can actualize plural measurement systems optically independent from each other. Specifically, a set of the cores 11c, 15c (a set of the first and second transmission paths) and a set of the cores 13c, 17c (a set of the first and second transmission paths) construct a measurement system 2A in the example of FIG. 5B. Similarly, a set of the cores 12c, 16c (a set of the first and second transmission paths) and a set of the cores 14c, 18c (a set of the first and second transmission paths) construct a measurement system 2B.

### Third Embodiment

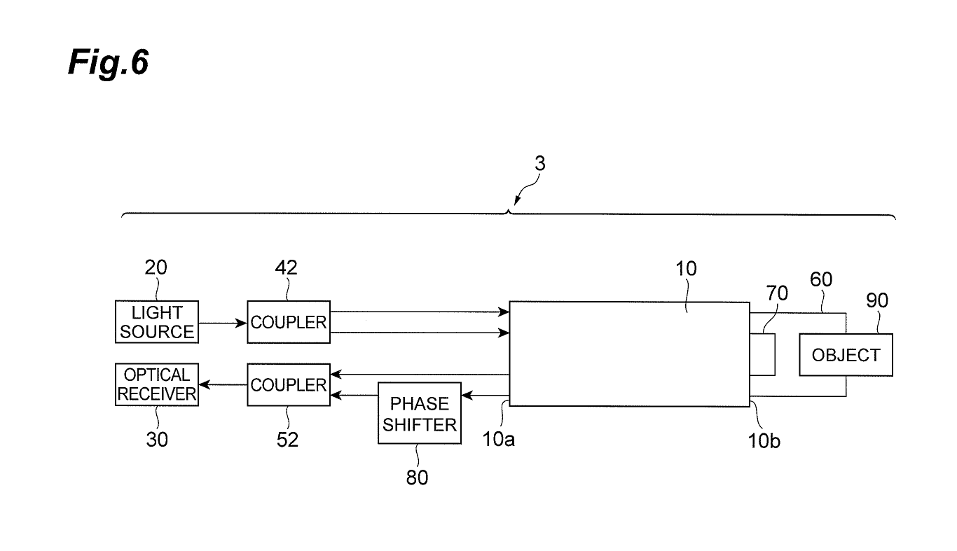

FIG. 6 is a diagram illustrating the structure of the interference measurement device according to the third embodiment. The interference measurement device 3 according to the third embodiment comprises a phase shifter 80 in addition to the structure of the interference measurement device 2 according to the second embodiment illustrated in FIG. 3. Except for this, the structure of the third embodiment is the same as that of the second embodiment. The phase shifter 80 is disposed between the first end 10a of the multi-core optical fiber 10 and the coupling unit 52, imparts a phase shift to at least one of the measurement light and reference light outputted from the first end 10a of the multi-core optical fiber 10, and feeds this light to the coupling unit 52.

This embodiment can exhibit the same effects as with the second embodiment. In addition, this embodiment can improve the sensitivity to changes in interference light intensity occurring in conjunction with phase changes caused by the object 90 or ameliorate the linearity of changes in interference light intensity occurring in conjunction with phase changes caused by the object 90. Controlling the phase shift amount provided by the phase shifter 80 such as to cancel out the phase shift amount caused by the object 90 makes it possible to detect the phase shift amount caused by the object 90.

As with the second embodiment (FIGS. 5A and 5B), the third embodiment can also actualize plural measurement systems (each having the same structure as that of the interference measurement device 3 illustrated in FIG. 6) optically independent from each other for each set of four cores by employing the multi-core optical fiber 10 having cores whose number is a multiple of 4.

### Fourth Embodiment

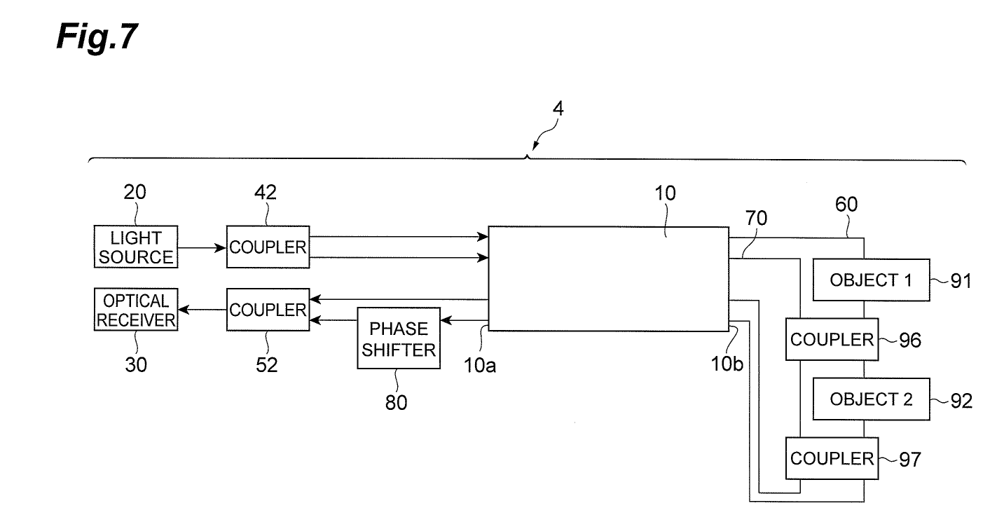

FIG. 7 is a diagram illustrating the structure of the interference measurement device according to the fourth embodiment. The interference measurement device 4 according to the fourth embodiment comprises couplers 96, 97 in addition to the structure of the interference measurement device 3 according to the third embodiment illustrated in FIG. 6. Except for this, the structure of the fourth embodiment is the same as that of the third embodiment. The couplers 96, 97 are provided in the measurement optical path 60 and reference optical path 70 on the second end 10b side of the multi-core optical fiber 10, so as to construct a multistage Mach-Zehnder interferometer.

This embodiment can exhibit the same effects as with the third embodiment. In addition, this embodiment constructs a multipoint interferometer corresponding to two objects to be measured 91, 92, which can be selectively measured when the phase shifter 80 provides the measurement light with a phase shift amount corresponding to the phase difference of the Mach-Zehnder interferometer including the object to be measured.

As with the second embodiment (FIGS. 5A and 5B), the fourth embodiment can also actualize plural measurement systems (each having the same structure as that of the interference measurement device 4 illustrated in FIG. 7) optically independent from each other for each set of four cores by employing the multi-core optical fiber 10 having cores whose number is a multiple of 4.

### Fifth Embodiment

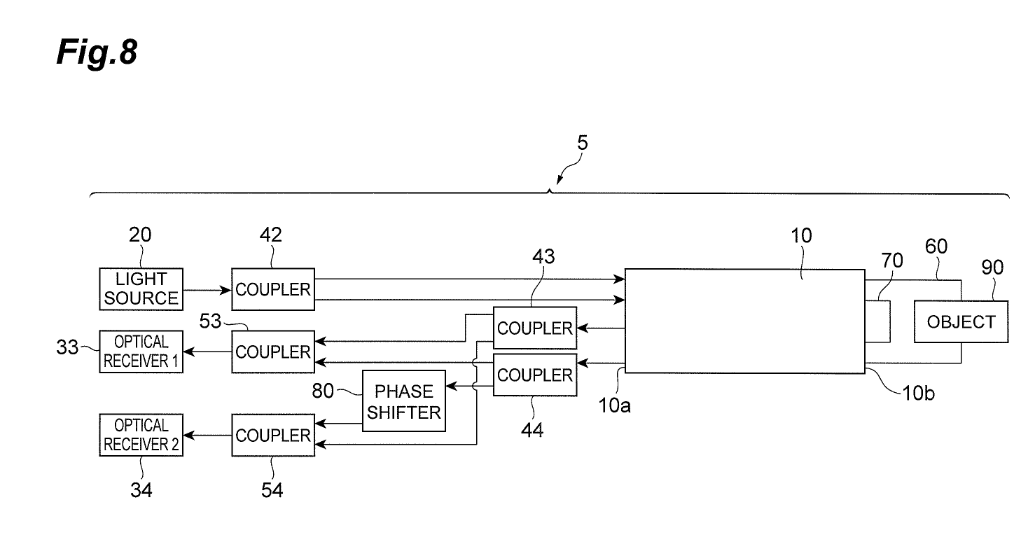

FIG. 8 is a diagram illustrating the structure of the interference measurement device according to the fifth embodiment. The interference measurement device 5 according to the fifth embodiment structurally differs from the interference measurement device 2 according to the second embodiment illustrated in FIG. 3 in that it comprises optical receivers 33, 34, branching units 43, 44, coupling units 53, 54, and a phase shifter 80 in place of the optical receiver 30 and coupling unit 52. Except for this, the structure of the fifth embodiment is the same as that of the second embodiment.

The measurement light outputted from the first end 10a of the multi-core optical fiber 10 is split by the branching unit 43 into two, which enter the coupling units 53, 54, respectively. The reference light outputted from the first end 10a of the multi-core optical fiber 10 is split by the branching unit 44 into two, one of which enters the coupling unit 53, while the other is provided with a phase shift by the phase shifter 80 and then enters the coupling unit 54. The measurement light and reference light having entered the coupling unit 53 interfere with each other as being coupled, and the resulting interference light is received by the optical receiver 33, whereby its intensity is detected. The measurement light and reference light having entered the coupling unit 54 interfere with each other as being coupled, and the resulting interference light is received by the optical receiver 34, whereby its intensity is detected.

This embodiment can exhibit the same effects as with the third embodiment. In addition, this embodiment can measure two kinds of interference light intensities with and without a phase shift and can achieve highly accurate measurement by signal processing of these two kinds of interference light intensities. Here, it is sufficient for the phase shifter 80 to provide at least one of the measurement light and reference light with the phase shift.

As with the second embodiment (FIGS. 5A and 5B), the fifth embodiment can also actualize plural measurement systems (each having the same structure as that of the interference measurement device 5 illustrated in FIG. 8) optically independent from each other for each set of four cores by employing the multi-core optical fiber 10 having cores whose number is a multiple of 4.

### Sixth Embodiment

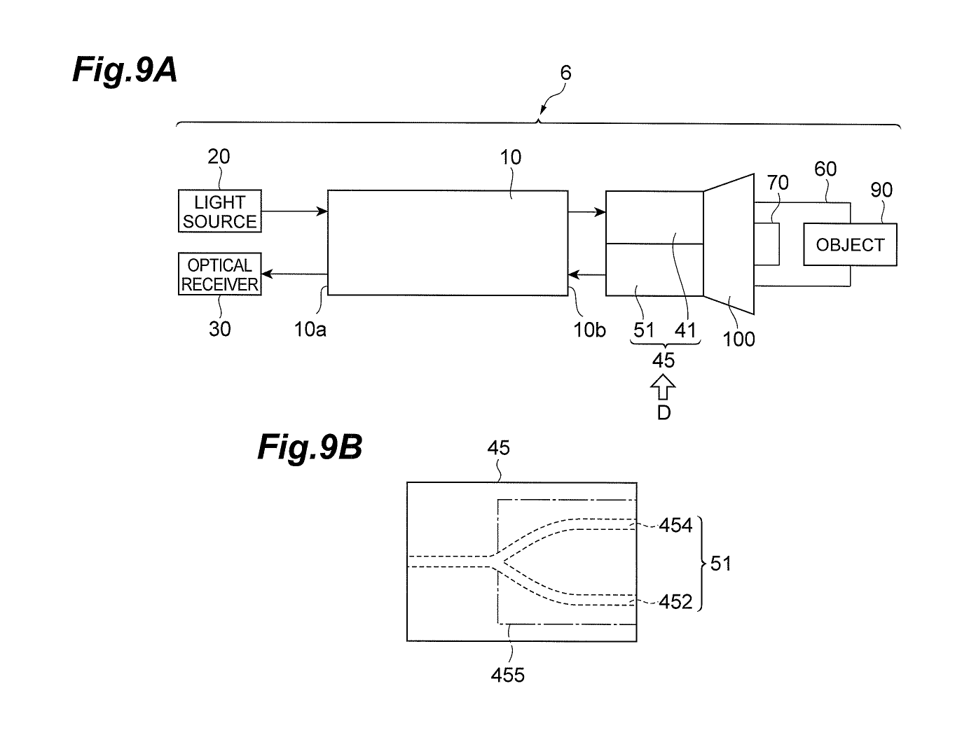

FIGS. 9A and 9B are diagrams illustrating the structure of the interference measurement device according to the sixth embodiment. As illustrated in FIG. 9A in particular, the interference measurement device 6 according to the sixth embodiment comprises a multi-core optical fiber 10, a light source 20, an optical receiver 30, a branching unit 41, a coupling unit 51, a measurement optical path 60, and a reference optical path 70 as with the interference measurement device 1 according to the first embodiment. In the interference measurement device 6 according to the sixth embodiment, the branching unit 41 and coupling unit 51 are constructed by one multi-core optical fiber coupler 45, while each of the branching unit 41 and coupling unit 51 is a multi-core optical fiber coupler. A fan-in/fan-out device 100 is disposed between the multi-core optical fiber coupler 45 and the measurement optical path 60 and reference optical path 70 in the interference measurement device 6 according to the sixth embodiment.

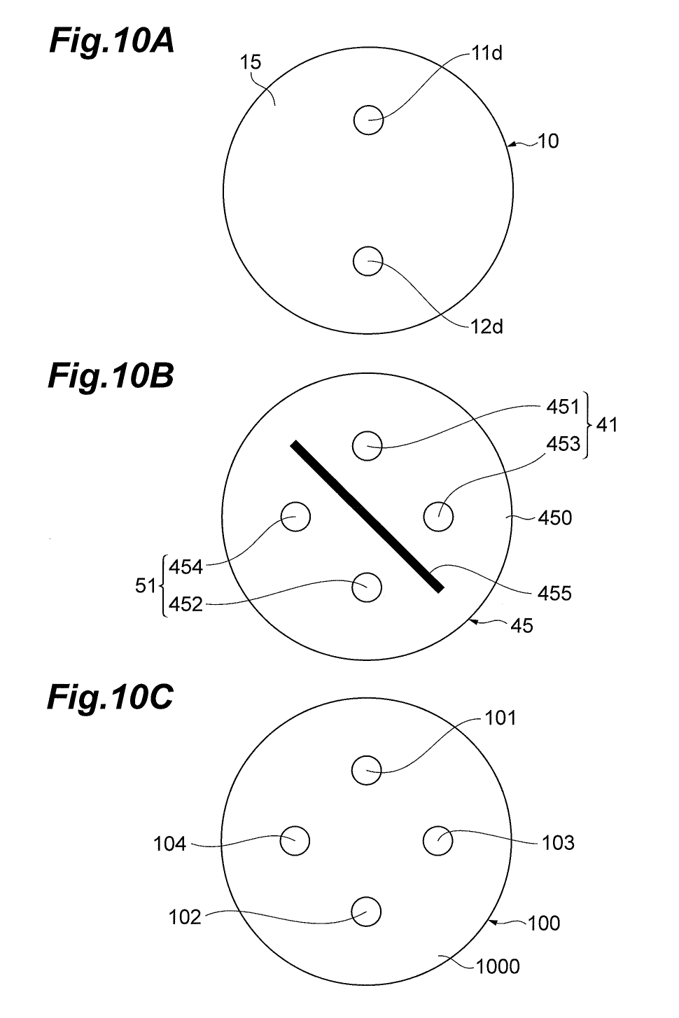

FIG. 9B is a diagram illustrating the structure of the multi-core optical fiber coupler 45 as seen in the direction of arrow D in FIG. 9A. FIGS. 10A to 10C are sectional views of components of the interference measurement device 6 according to the sixth embodiment. As illustrated in FIG. 10A, the multi-core optical fiber 10 has two cores 11d, 12d extending between the first end 10a and second end 10b within a common cladding. As illustrated in FIGS. 9B and 10B, the multi-core optical fiber coupler 45 has four cores 451 to 454 extending between one end and the other end within a common cladding 450 and a leakage reduction unit 455 disposed between a set of the cores 451, 453 and a set of the cores 452, 454. As illustrated in FIG. 10C, the fan-in/fan-out device 100 has four cores 101 to 104 extending between one end and the other end within a common cladding 1000.

The core 11d of the multi-core optical fiber 10 is optically coupled to the core 451 of the multi-core optical fiber 45. The core 12d of the multi-core optical fiber 10 is optically coupled to the core 452 of the multi-core optical fiber 45. The cores 451, 453 of the multi-core optical fiber coupler 45 generate crosstalk therebetween, thereby constructing the branching unit 41. The cores 452, 454 of the multi-core optical fiber coupler 45 also generate crosstalk therebetween, thereby constructing the coupling unit 51. Since the leakage reduction unit 455 is provided, no crosstalk occurs between the set of cores 451, 453 and set of cores 452, 454 in the multi-core optical fiber coupler 45.

The core 451 of the multi-core optical fiber coupler 45 is optically coupled to the core 101 of the fan-in/fan-out device 100. The core 452 of the multi-core optical fiber coupler 45 is optically coupled to the core 102 of the fan-in/fan-out device 100. The core 453 of the multi-core optical fiber coupler 45 is optically coupled to the core 103 of the fan-in/fan-out device 100. The core 454 of the multi-core optical fiber coupler 45 is optically coupled to the core 104 of the fan-in/fan-out device 100.

Light outputted from the light source 20 enters the core 11d at the first end 10a of the multi-core optical fiber 10 and exits from the core 11d at the second end 10b to the core 451 of the multi-core optical fiber coupler 45. The light having entered the core 451 of the multi-core optical fiber coupler 45 is split into measurement light and reference light through the crosstalk between the cores 451, 453 constituting the branching unit 41.

The measurement light outputted from the core 451 of the multi-core optical fiber coupler 45 enters the core 452 of the multi-core optical fiber coupler 45 through the core 101 of the fan-in/fan-out device 100, the measurement optical path 60 where the object 90 exists, and the core 102 of the fan-in/fan-out device 100. The reference light outputted from the core 453 of the multi-core optical fiber coupler 45 enters the core 454 of the multi-core optical fiber coupler 45 through the core 103 of the fan-in/fan-out device 100, the reference optical path 70, and the core 104 of the fan-in/fan-out device 100.

A part of the reference light having entered the core 454 of the multi-core optical fiber coupler 45 branches off into the core 452 due to the crosstalk between the cores 452, 454 constituting the coupling unit 51. The light received by the optical receiver 30 through the core 12 of the multi-core optical fiber coupler 10 after being outputted from the core 452 of the multi-core optical fiber coupler 45 is interference light generated by interference between the measurement light and reference light. The intensity of this interference light is detected by the optical receiver 30.

A multi-core optical fiber coupler is disclosed in Japanese Patent Application Laid-Open No. 2011-237782. In this embodiment, two couplers are constructed in the multi-core optical fiber coupler 45. That is, the cores 451, 453 constitute a coupler, while the cores 452, 454 constitute a coupler. Therefore, crosstalk occurs between the cores 451, 453 constituting one coupler. While the cores 452, 454 constituting the other coupler generate crosstalk, the crosstalk between one coupler (cores 451, 453) and the other coupler (cores 452, 454) is desired to be as small as possible.

The multi-core optical fiber coupler 45 is provided with the leakage reduction unit 455 for reducing the crosstalk between the two couplers. The leakage reduction unit 455 is disposed between one coupler (cores 451, 453) and the other coupler (cores 452, 454) and can reduce the influence of leakage of light (crosstalk) therebetween. The leakage reduction unit 455 may be a region having a refractive index lower than that of the cladding or a region which absorbs or scatters light. In the former case, the leakage reduction unit 455 may be constructed by silica glass doped with a refractive index lowering agent such as elemental F, plural axially extending holes, or a region where plural voids are dispersed.

In the multi-core optical fiber coupler 45, the light propagation direction of one coupler (cores 451, 453) and that of the other coupler (cores 452, 454) are opposite from each other. Such a structure is also effective in reducing the crosstalk between one coupler (cores 451, 453) and the other coupler (cores 452, 454).

For optically coupling each core of the multi-core optical fiber 10 to its corresponding core in the multi-core optical fiber coupler 45, it is necessary for the respective core arrangements of the multi-core optical fiber 10 and multi-core optical fiber coupler 45 to align with each other. Under this condition, it is necessary for the inter-core crosstalk in the couplers constructed in the multi-core optical fiber coupler 45 to be at a predetermined level or higher, while reducing the inter-core crosstalk in the multi-core optical fiber 10. As a means for achieving this, a leakage reduction unit may be provided between the cores of the multi-core optical fiber 10, but not between the cores of the couplers constructed in the multi-core optical fiber coupler 45. As a structure of the leakage reduction unit, those mentioned above can be employed.

The following can also be used as another means. That is, while securing such an interval as to yield a desirable level of inter-core crosstalk in the multi-core optical fiber 10 as a core interval of the multi-core optical fibers 10, 45, in order to achieve inter-core crosstalk necessary for the couplers constructed by the multi-core optical fiber coupler 45 under this condition, a part of the multi-core optical fiber 45 may be molten and extended, so as to narrow the core interval and reduce the core size, thereby lowering the ratio of light confined in the core part.

The interference measurement device 6 according to this embodiment acts and is effective as with the interference measurement device 1 of the first embodiment mentioned above. In addition, the interference measurement device 6 of this embodiment can be constructed by interconnections between the multi-core optical fibers 10, 45 and the fan-in/fan-out device 100 and thus is simple in structure.

By employing the multi-core optical fiber 10 having cores whose number is a multiple of 2 as in the first embodiment (FIGS. 2A and 2B), the sixth embodiment can also actualize plural measurement systems (each having the same structure as that of the interference measurement device 6 illustrated in FIGS. 9A and 9B) optically independent from each other for each set of two cores.

### Seventh Embodiment

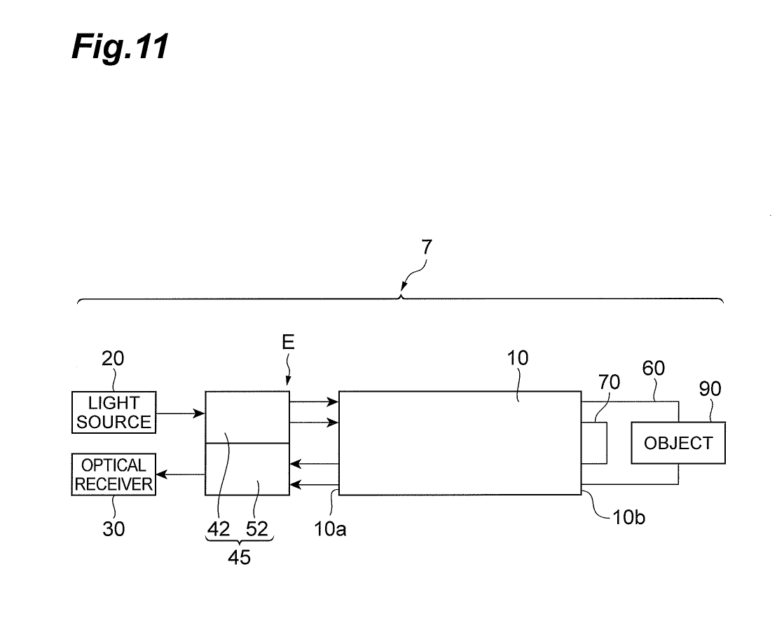

FIG. 11 is a diagram illustrating the structure of the interference measurement device 7 according to the seventh embodiment. As with the interference measurement device 2 according to the second embodiment, the interference measurement device 7 according to the seventh embodiment comprises a multi-core optical fiber 10, a light source 20, an optical receiver 30, a branching unit 42, a coupling unit 52, a measurement optical path 60, and a reference optical path 70. In the interference measurement device 7 according to the seventh embodiment, the branching unit 42 and coupling unit 52 are constructed by one multi-core optical fiber coupler 45, while each of the branching unit 42 and coupling unit 52 is a multi-core optical fiber coupler. A fan-in/fan-out device may be disposed at the second end 10b of the multi-core optical fiber 10. In this case, the fan-in/fan-out device may be constructed as in the sixth embodiment.

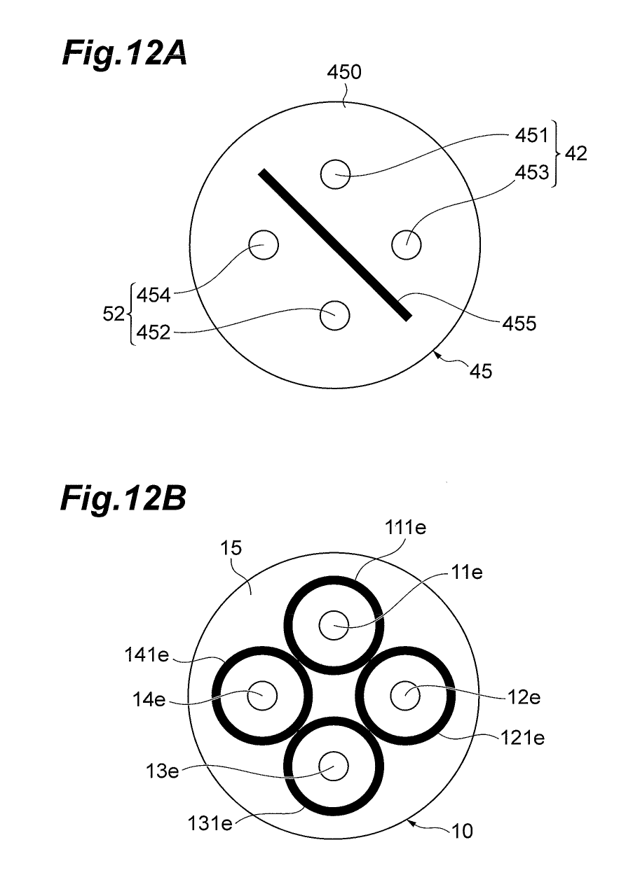

FIGS. 12A and 12B are sectional views of components of the interference measurement device 7 according to the seventh embodiment. As illustrated in FIG. 12A, the multi-core optical fiber coupler 45 has four cores 451 to 454 extending between one end and the other end within a common cladding 450 and a leakage reduction unit 455 disposed between a set of the cores 451, 453 and a set of the cores 452, 454. The cores 451, 453 of the multi-core optical fiber coupler 45 generate crosstalk therebetween, thereby constructing the branching unit 42. The cores 452, 454 of the multi-core optical fiber coupler 45 also generate crosstalk therebetween, thereby constructing the coupling unit 52. Since the leakage reduction unit 455 is provided, no crosstalk occurs between the set of cores 451, 453 and set of cores 452, 454 in the multi-core optical fiber coupler 45.

As illustrated in FIG. 12B, the multi-core optical fiber 10 has four cores 11e to 14e extending between the first end 10a and second end 10b within a common cladding 15. A leakage reduction unit 111e is disposed within the cladding about the core 11e so as to surround the latter. A leakage reduction unit 121e is disposed within the cladding about the core 12e so as to surround the latter. A leakage reduction unit 131e is disposed within the cladding about the core 13e so as to surround the latter. A leakage reduction unit 141e is disposed within the cladding about the core 14e so as to surround the latter. The leakage reduction units 111e to 141e are disposed in regions where light has substantially no power to propagate through the cores. As with the leakage reduction unit 455, the leakage reduction units 111e to 141e may be regions having a refractive index lower than that of the cladding 15 or regions which absorb or scatter light.

Light outputted from the light source 20 enters the core 451 of the multi-core optical fiber coupler 45 and is split into measurement light and reference light through the crosstalk between the cores 451, 453 constituting the branching unit 42. The measurement light outputted from the core 451 of the multi-core optical fiber coupler 45 enters the first core 11e of the multi-core optical fiber 10 at the first end 10a and exits from the first core 11e at the second end 10b to the measurement optical path 60 where the object 90 exists. The light having traveled the measurement optical path 60 enters the second core 13e of the multi-core optical fiber 10 at the second end 10b and exits from the second core 13e at the first end 10a to the core 452 constituting the coupling unit 52.

The reference light outputted from the core 453 of the multi-core optical fiber coupler 45 enters the third core 12e of the multi-core optical fiber 10 at the first end 10a and exits from the third core 12e at the second end 10b to the reference optical path 70. The light having traveled the reference optical path 70 enters the fourth core 14e of the multi-core optical fiber 10 at the second end 10b and exits from the fourth core 14e at the first end 10a to the core 454 constituting the coupling unit 52. The measurement light and reference light having entered the coupling unit 52 interfere with each other as being coupled, and the resulting interference light is received by the optical receiver 30, whereby the intensity is detected.

The interference measurement device 7 according to this embodiment acts and is effective as with the interference measurement device 2 of the second embodiment mentioned above. In addition, the interference measurement device 7 of this embodiment can be constructed by interconnections between the multi-core optical fiber 10, multi-core optical fiber coupler 45, and fan-in/fan-out device and thus is simple in structure.

By employing the multi-core optical fiber 10 having cores whose number is a multiple of 4 as in the second embodiment (FIGS. 5A and 5B), the seventh embodiment can also actualize plural measurement systems (each having the same structure as that of the interference measurement device 7 illustrated in FIG. 11) optically independent from each other for each set of four cores.

### Eighth Embodiment

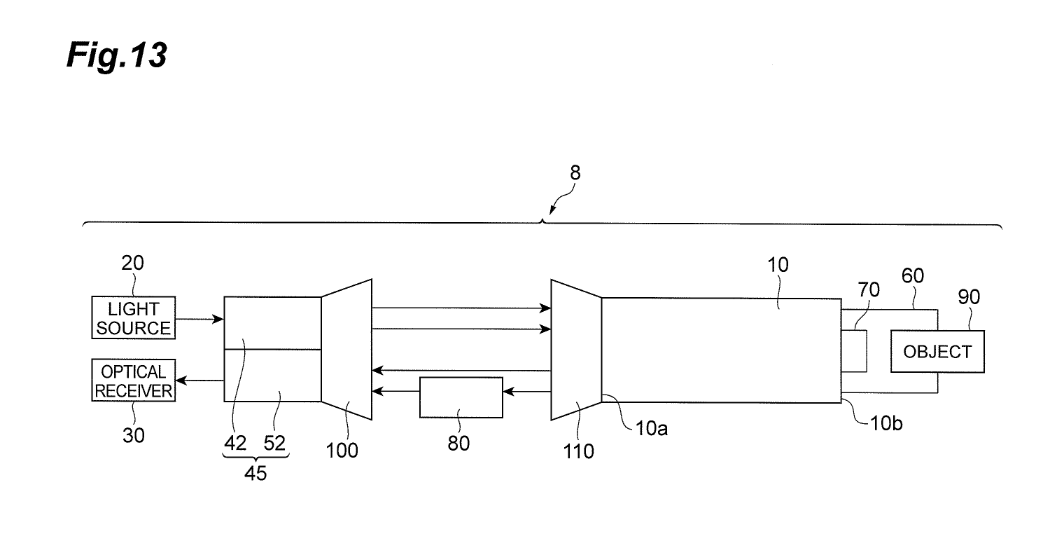

FIG. 13 is a diagram illustrating the structure of the interference measurement device according to the eighth embodiment. The interference measurement device 8 according to the eighth embodiment comprises fan-in/fan-out devices 100, 110 and a phase shifter 80 in addition to the structure of the interference measurement device 7 according to the seventh embodiment. The fan-in/fan-out device 100 is disposed on the multi-core optical fiber 10 side of the multi-core optical fiber coupler 45. Except for this, the structure of the eighth embodiment is the same as that of the seventh embodiment. The fan-in/fan-out device 110 is disposed at the first end 10a of the multi-core optical fiber 10. The phase shifter 80 is interposed between one core of the fan-in/fan-out device 100 and one core of the fan-in/fan-out device 110. A fan-in/fan-out device may also be disposed at the second end 10b of the multi-core optical fiber 10. In this case, the fan-in/fan-out device may be constructed as in the sixth embodiment.

The interference measurement device 8 according to this embodiment acts and is effective as with the interference measurement device 3 of the third embodiment mentioned above. In addition, the interference measurement device 8 of this embodiment can be constructed by interconnections between the multi-core optical fibers 10, 45 and fan-in/fan-out devices 100, 110 and thus is simple in structure.

As with the second embodiment (FIGS. 5A and 5B), the eighth embodiment can also actualize plural measurement systems (each having the same structure as that of the interference measurement device 3 illustrated in FIG. 6) optically independent from each other for each set of four cores by employing the multi-core optical fiber 10 having cores whose number is a multiple of 4.

The interference measurement devices according to embodiments can measure various types of physical quantities in a simple structure.

What is claimed is:

1. An interference measurement device, comprising:
a multi-core optical fiber having a first end and a second end opposing the first end, the multi-core optical fiber having plural cores extending between the first and second ends, and a common cladding covering the plural cores;
a light source disposed on the first end side of the multi-core optical fiber;
an optical receiver disposed on the first end side of the multi-core optical fiber;
a measurement optical path disposed on the second end side of the multi-core optical fiber;
a reference optical path disposed on the second end side of the multi-core optical fiber;
a branching unit configured to split light outputted from the light source into measurement light for propagating through the measurement optical path and reference light for propagating through the reference optical path; and
a coupling unit configured to generate interference light between the measurement light and reference light by coupling the measurement light having propagated through the measurement optical path and the reference light having propagated through the reference optical path, and to feed thus generated interference light to the optical receiver,
wherein the plural cores of the multi-core optical fiber include at least one core belonging to a first transmission path and at least one core belonging not to the first transmission path but to a second transmission path, the first transmission path propagating light from the first end to the second end, the second transmission path propagating light from the second end to the first end.

2. The interference measurement device according to claim 1, wherein the multi-core optical fiber is substantially free of a sensing function.

3. The interference measurement device according to claim 1, wherein the branching unit is disposed on the second end side of the multi-core optical fiber and splits the light from the light source outputted from the core belonging to the first transmission path at the second end of the multi-core optical fiber into the measurement light and reference light.

4. The interference measurement device according to claim 3, wherein the coupling unit is disposed on the second end side of the multi-core optical fiber and feeds interference light between the measurement light having propagated through the measurement optical path and the reference light having propagated through the reference optical path to a core belonging to the second transmission path from the second end side of the multi-core optical fiber.

5. The interference measurement device according to claim 1, wherein the branching unit is disposed on the first end side of the multi-core optical fiber, feeds the measurement light split from the light outputted from the light source into a core belonging to the first transmission path from the first end side of the multi-core optical fiber, and feeds the reference light split from the light outputted from the light source into another core belonging to the first transmission path from the first end side of the multi-core optical fiber.

6. The interference measurement device according to claim 5, wherein the coupling unit is disposed on the first end side of the multi-core optical fiber, couples the measurement light and reference light outputted from the first end of the multi-core optical fiber after having propagated through respective two cores different from each other belonging to the second transmission path, so as to generate the interference light, and feeds thus generated interference light into the optical receiver.

7. The interference measurement device according to claim 6, wherein the multi-core optical fiber has first, second, third, and fourth cores as the plural cores;
wherein, in a cross section perpendicular to a center axis of the multi-core optical fiber, the first and second cores are arranged at positions symmetrical to each other about the center axis, while the third and fourth cores are arranged at positions symmetrical to each other about the center axis; and
wherein the first and third cores belong to the first transmission path, while the second and fourth cores belong to the second transmission path.

8. The interference measurement device according to claim 5, wherein each of the plural cores of the multi-core optical fiber is a polarization-maintaining core.

9. The interference measurement device according to claim 5, wherein at least one of the measurement light and reference light is depolarized or polarization-scrambled.

10. The interference measurement device according to claim 1, comprising a multi-core optical fiber coupler adapted to function as the branching and coupling units;
wherein the multi-core optical fiber coupler has:
a cladding incorporating plural core-groups therein, each of the plural core-groups being configured to branch off part of light propagating through one core to the other core or couple light propagating through one core and light propagating through the other core; and
a leakage reduction unit, incorporated in the cladding and disposed between different core-groups of the plural core-groups, for suppressing crosstalk between the different core-groups,
wherein each of the plural core-groups includes plural cores adapted to branch or couple light due to crosstalk between cores within the same core-group.

11. A multi-core optical fiber coupler comprising:
a cladding incorporating plural core-groups therein, each of the plural core-groups being configured to branch off part of light propagating through one core to the other core or couple light propagating through one core and light propagating through the other core; and
a leakage reduction unit, incorporated in the cladding and disposed between different core-groups of the plural core-groups, for suppressing crosstalk between the different core-groups,
wherein each of the plural core-groups includes plural cores configured to branch or couple light due to crosstalk between cores within the same core-group.
